(19) United States
(12) Patent Application Publication
(10) Pub. No.: US 2006/0089430 A1
(43) Pub. Date: Apr. 27, 2006

(54) Curable composition

(75) Inventors: Atsushi Kawakami, Takasago-shi (JP); Katsuhiro Ando, Akashi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KANEKA CORPORATION, Osaka (JP)

(21) Appl. No.: 11/255,862

(22) Filed: Oct. 24, 2005

Related U.S. Application Data
(60) Provisional application No. 60/628,954, filed on Nov. 19, 2004.

(30) Foreign Application Priority Data
Oct. 25, 2004 (JP) 2004-310130

(51) Int. Cl. C08L 95/00

(52) U.S. Cl. 524/59

(57) ABSTRACT

A curable composition contains a bituminous substance (A) and a saturated hydrocarbon polymer (B) having a reactive silicon group represented by general formula (1):
—Si(R¹₃₋ₐ)Xₐ (1)
(wherein R¹ is a C₁-C₂₀ alkyl group, a C₆-C₂₀ aryl group, a C₇-C₂₀ aralkyl group, or a triorganosiloxy group represented by (R′O)₃Si—; when two R¹s are present, they may be the same or different; the three R's each represent a C₁-C₂₀ monovalent hydrocarbon group and may be the same or different; X is a hydroxyl group or hydrolyzable group; when two or more Xs are present, they may be the same or different; and a is 1, 2, or 3).

### BACKGROUND OF THE INVENTION

1. Field of the Invention

The present invention relates to a curable composition containing a bituminous substance and a reactive silicon group-containing saturated hydrocarbon polymer. It also relates to a tile adhesive, a waterproof material, a road paving material, a water stopping material for civil engineering, and a damping material containing the curable composition.

2. Description of the Related Art

Bituminous substances such as asphalt have excellent adhesiveness, workability, and waterproofing property and are inexpensive. Thus, they are widely used in the fields of road paving materials, roofing materials, sealing materials, adhesives, waterway lining materials, damping materials, and sound insulating materials.

For example, in using asphalt as a roofing material, a hot process for asphalt waterproofing in which a plurality of layers of asphalt is laminated to form a waterproofing layer has been widely used as the mainstream of waterproofing work. Although the hot process has high waterproofing reliability, it has drawbacks in that, when asphalt is melted, significantly large amounts of fumes and odor generated from the molten asphalt contaminate the surrounding environment. Thus, the hot process has been avoided in thickly housed areas and central urban areas, and the area that can use the hot process has been limited. Moreover, workers face dangers of burn injury and thus tend to avoid the hot process.

To overcome these problems, a self-adhesion process, which is one of cold processes, has been developed and gaining popularity. However, in this process, a large number of sheets of releasing paper separated during the working must be discarded, and this poses a serious problem.

With respect to the performance, blown asphalt, which has been subjected to air blowing treatment, is generally used in the roofing material applications. However, the blown asphalt is frequently brittle due to its hardness and breaking of materials caused by ambient temperature, and thus breaks easily at low temperature. In contrast, asphalt having satisfactory low temperature properties may undergo fluidization or deformation beyond acceptable levels in summer. An epoxy resin-asphalt system has been developed to overcome this problem, and the problem of rutting in the summer has thus been overcome with the increased strength. However, the problem of cracking in winter is not yet overcome.

In recent years, an attempt to impart elasticity by adding a rubber modifier, such as natural rubber, styrene-butadiene rubber, or chloroprene rubber, has been made to overcome the problem of cracking (refer to Japanese Unexamined Patent Application Publication No. 10-279808). However, these rubber modifiers have low compatibility with asphalt and do not easily give a homogenous composition. Thus, it requires a long time of stirring under high temperature to disperse the modifier in the asphalt. As a result, the modification of the asphalt by the rubber modifier may become insufficient, thereby resulting in insufficient adhesion to base materials and unsatisfactory waterproofing/water stopping performance.

### SUMMARY OF THE INVENTION

Accordingly, it is an object of the present invention to provide a cold-setting asphalt composition that produces neither fume nor odor during working, causes no evaporation of the solvent, and has satisfactory waterproof adhesiveness to mortar.

The present inventors have conducted extensive studies and found that a curable composition having satisfactory water resistance can be obtained by mixing a bituminous substance with a saturated hydrocarbon polymer having a reactive silicon group. The present invention is made based on this finding.

The present invention provides the following (1) to (18):

(1) A curable composition including a bituminous substance (A); and a saturated hydrocarbon polymer (B) having a reactive silicon group represented by general formula (1):
—Si(R¹₃₋ₐ)Xₐ (1)
(wherein R¹ is a C₁-C₂₀ alkyl group, a C₆-C₂₀ aryl group, a C₇-C₂₀ aralkyl group, or a triorganosiloxy group represented by (R′O)₃Si—; when two R¹s are present, they may be the same or different; the three R's each represent a C₁-C₂₀ monovalent hydrocarbon group and may be the same or different; X is a hydroxyl group or hydrolyzable group; when two or more Xs are present, they may be the same or different; and a is 1, 2, or 3);

(2) The curable composition described in (1), in which the saturated hydrocarbon polymer (B) has a main chain skeleton composed of polyisobutylene;

(3) The curable composition described in (1) or (2) above, further containing a plasticizer (C);

(4) The curable composition described in (3), in which the plasticizer (C) is an aromatic oligomer or a completely or partially hydrogenated aromatic oligomer;

(5) The curable composition described in (3) above, in which the plasticizer (C) is a sulfonate compound or a sulfonamide compound;

(6) The curable composition described in any one of (1) to (5) above, further including an epoxy resin (D);

(7) The curable composition described in (6), in which the epoxy resin (D) is contained in an amount of 5 to 120 parts by weight per 100 parts by weight of the bituminous substance (A);

(8) The curable composition described in any one of (1) to (7) above, further including a (meth)acrylic acid alkyl ester polymer (E);

(9) The curable composition described in (8) above, in which a molecular chain of the (meth)acrylic acid alkyl ester polymer (E) is a copolymer of a (meth)acrylic acid alkyl ester monomer unit (a) having a C₁-C₈ alkyl group and a (meth)acrylic acid alkyl ester monomer unit (b) having a C₁₀ or higher alkyl group;

(10) The curable composition described in (8) or (9 above, in which the (meth)acrylic acid alkyl ester polymer (E) is a polymer having a reactive silicon group represented by general formula (1) above;

(11) The curable composition described in any one of (1) to (10) above, further including a tackifier resin (F);

(12) The curable composition described in (11), in which the tackifier resin (F) is a tackifier resin modified with phenol and/or alkylphenol;

(13) The curable composition described in any one of (1) to (12) above, in which the bituminous substance (A) contains a natural asphalt and/or a petroleum asphalt;

(14) A tile adhesive including the curable composition described in any one of (1) to (13) above;

(15) A waterproof material including the curable composition described in any one of (1) to (13) above;

(16) A road paving material including the curable composition described in any one of (1) to (13) above;

(17) A water stopping material for civil engineering, the water stopping material including the curable composition described in any one of (1) to (13) above; and

(18) A damping material including the curable composition described in any one of (1) to (13) above.

A curable composition having excellent water resistance, curability, and storage stability, requiring no thermal melting during working, and generating no fume or odor is thus provided.

### DESCRIPTION OF THE PREFERRED EMBODIMENTS

A bituminous substance (A) of the present invention may be a natural asphalt, e.g. a rock asphalt or a lake asphalt such as Trinidad epure, gilsonite, or pyrobitumen, or a cut-back asphalt thereof; a petroleum asphalt or pitch such as a straight asphalt or a blown asphalt produced by a petroleum refining process, or a cut-back asphalt thereof; a mixed bitumen such as pitch bitumen or a pitch mixture; or petroleum process oil such as heavy catalytically cracked cycle oil, light catalytically cracked cycle oil, lubricating oil, a distillate thereof, or another distillate subjected to treatment such as extraction, refinement, hydrogenation, or the like. A mixture of these may also be used as the bituminous substance (A). In particular, the straight asphalt produced by petroleum refinery processes is particularly preferable since high compatibility and stable dispersibility are exhibited between the straight asphalt and the component (B).

The meaning of the “main chain skeleton of a reactive silicon group-containing saturated hydrocarbon polymer (B)” in this invention is “a polymer containing substantially no C—C unsaturated bond other than aromatic rings”. The polymer which forms the main chain skeleton of the reactive silicon group-containing saturated hydrocarbon polymer used in the present invention can be produced by the following processes:

(I) a process of polymerizing a C₁-C₆ olefin compound, such as ethylene, propylene, 1-butene, or isobutylene, serving as a main monomer; and

(II) a process of homopolymerizing a diene compound, such as butadiene or isoprene, or copolymerizing the above-described olefin compound and a diene compound, followed by hydrogenation.

Among these polymers, isobutylene polymers and hydrogenated polybutadiene polymers are preferable since it becomes easy to introduce functional groups to the termini, to control the molecular weight, and to increase the number of terminal functional groups.

All of the monomer units of the isobutylene polymer may be composed of isobutylene units. Alternatively, the isobutylene polymer may contain 50 wt % or less, preferably 30 wt % or less, and more preferably 10 wt % or less of monomer units copolymerizable with isobutylene.

Examples of the monomer component include C₄-C₁₂ olefins, vinyl ethers, aromatic vinyl compounds, vinylsilanes, and allylsilanes. Examples of the copolymer component include 1-butene, 2-butene, 2-methyl-1-butene, 3-methyl-1-butene, pentene, 4-methyl-1-pentene, hexene, vinylcyclohexane, methyl vinyl ether, ethyl vinyl ether, isobutyl vinyl ether, styrene, α-methylstyrene, dimethylstyrene, monochlorostyrene, dichlorostyrene, β-pinene, indene, vinyltrichlorosilane, vinylmethyldichlorosilane, vinyldimethylchlorosilane, vinyldimethylmethoxysilane, vinyltrimethylsilane, divinyldichlorosilane, divinyldimethoxysilane, divinyldimethylsilane, 1,3-divinyl-1,1,3,3-tetramethyldisiloxane, trivinylmethylsilane, tetravinylsilane, allyltrichlorosilane, allylmethyldichlorosilane, allyldimethylchlorosilane, allyldimethylmethoxysilane, allyltrimethylsilane, diallyldichlorosilane, diallyldimethoxysilane, diallyldimethylsilane, γ-methacryloyloxypropyltrimethoxysilane, and γ-methacryloyloxypropylmethyldimethoxysilane.

When a vinylsilane or an allylsilane is used as the monomer copolymerizable with isobutylene, the silicon content in the polymer can be increased, the number of the groups that can act as a silane coupling agent can be increased, and the adhesiveness of the resulting composition can be enhanced.

As with the isobutylene polymer, the hydrogenated polybutadiene polymer or the other saturated hydrocarbon polymer may contain other monomer units in addition to the main component monomer unit.

As long as the object of the present invention is achieved, the saturated hydrocarbon polymer used in the present invention may contain small amounts of, preferably 10% or less, more preferably 5% or less, and most preferably 1% or less of monomer units having double bonds after the polymerization. Examples of such monomer units include polyene compounds such as butadiene and isoprene.

The number-average molecular weight of the saturated hydrocarbon polymer, in particular, the isobutylene polymer or the hydrogenated polybutadiene polymer, is preferably 500 to 100,000 in terms of polystyrene determined by gel permeation chromatography (GPC). In particular, a saturated hydrocarbon polymer having a number-average molecular weight of 1,000 to 30,000 is preferable from the standpoint of handling ease since such a polymer is liquid and/or has fluidity. Moreover, the molecular weight distribution (Mw/Mn) is preferably as small as possible since the viscosity for the same molecular weight decreases as a result.

A process for preparing a saturated hydrocarbon polymer having a reactive silicon group represented by the formula (1) will now be described:
—Si(R¹₃₋ₐ)Xₐ (1)
(wherein R¹ is a C₁-C₂₀ alkyl group, a C₆-C₂₀ aryl group, a C₇-C₂₀ aralkyl group, or a triorganosiloxy group represented by (R′O)₃Si—; when two R¹s are present, they may be the same or different; the three R's each represent a C₁-C₂₀ monovalent hydrocarbon group and may be the same or different; X is a hydroxyl group or hydrolyzable group; when two or more Xs are present, they may be the same or different; and a is 1, 2, or 3). The processes of producing an isobutylene polymer and a hydrogenated polybutadiene polymer are described here as examples.

Among the isobutylene polymers having the above-described reactive silicon groups, an isobutylene polymer having a reactive silicon group at a molecular terminus can be prepared using an isobutylene polymer having some or, preferably, all of its termini occupied by functional groups, the isobutylene polymer being prepared by an iniferter polymerization method (i.e., a cationic polymerization method of using a particular compound that serves as both an initiator and a chain transfer agent). This production method is disclosed in Japanese Unexamined Patent Application Publication Nos. 63-006003, 63-006041, 63-254149, 64-022904, and 64-038407, for example. It is particularly preferable to produce an isobutylene polymer having a reactive silicon group at the end by addition reaction of an unsaturated group-terminated isobutylene polymer and a hydrosilane compound having a hydrogen atom bonded to a group represented by general formula (1) in the presence of a platinum catalyst.

An isobutylene polymer having a reactive silicon group in the molecule is produced by adding a vinylsilane or allylsilane having a reactive silicon group to a monomer mainly composed of isobutylene to perform copolymerization.

An isobutylene polymer having reactive silicon groups at a terminus and inside the molecular chain may be produced by preparing a reactive silicon group-terminated isobutylene polymer by polymerization so that the main component, i.e., an isobutylene monomer, is copolymerized with a vinylsilane or allylsilane having a reactive silicon group, and then introducing a reactive silicon group at a terminus of the resulting copolymer.

Examples of the vinylsilane and allylsilanes having reactive silicon groups include vinyltrichlorosilane, vinylmethyldichlorosilane, vinyldimethylchlorosilane, vinyldimethylmethoxysilane, divinyldichlorosilane, divinyldimethoxysilane, allyltrichlorosilane, allylmethyldichlorosilane, allyldimethylchlorosilane, allyldimethylmethoxysilane, diallyldichlorosilane, diallyldimethoxysilane, γ-methacryloyloxypropyltrimethoxysilane, and γ-methacryloyloxypropylmethyldimethoxysilane.

An example of the process for producing a hydrogenated polybutadiene polymer is as follows. First, the hydroxyl group of a hydroxyl-terminated hydrogenated polybutadiene polymer is converted to an oxymetal group, such as —ONa or —OK. The resulting polymer is then reacted with an organohalide represented by general formula (2) below to produce a hydrogenated polybutadiene polymer having a terminal olefin group (hereinafter this polymer is also referred to as “olefin-terminated hydrogenated polybutadiene polymer”):
CH₂═CH—R²—Y (2)
(wherein Y is a halogen atom, such as a chlorine atom or an iodine atom; R² is —R³—, —R³—OC(═O)—, or —R³—C(═O)— (wherein R³ is a C₁-C₂₀ divalent hydrocarbon group and is preferably alkylene, cycloalkylene, arylene, or aralkylene) and is preferably a divalent organic group selected from —CH₂— and —R⁴-Ph-CH₂— (wherein R⁴ is a C₁-C₁₀ hydrocarbon group and Ph is a p-phenylene group)).

Examples of the process of converting the terminal hydroxyl group of the hydroxyl-terminated hydrogenated polybutadiene polymer to the oxymetal group include those processes in which the polymer is reacted with alkali metals such as Na and K, metal hydrides such as NaH, metal alkoxides such as NaOCH₃, and caustic alkalis such as NaOH and KOH.

By the above-described methods, an olefin-terminated hydrogenated polybutadiene polymer having substantially the same molecular weight as the starting material, i.e., the hydroxyl-terminated hydrogenated polybutadiene polymer, can be obtained. In order to obtain a polymer having a higher molecular weight, prior to the reaction with the organohalide represented by general formula (2), the polymer is reacted with a polyvalent organohalide containing two or more halogen atoms per molecule, such as methylene chloride, bis(chloromethyl)benzene, or bis(chloromethyl)ether to increase the molecular weight, and then reacted with the organohalide represented by general formula (2) above. In this manner, an olefin-terminated hydrogenated polybutadiene polymer having a higher molecular weight can be obtained.

Examples of the organohalide represented by general formula (2) include, but are not limited to, allyl chloride, allyl bromide, vinyl(chloromethyl)benzene, allyl(chloromethyl)benzene, allyl(bromomethyl)benzene, allyl(chloromethyl)ether, allyl(chloromethoxy)benzene, 1-butenyl(chloromethyl)ether, 1-hexenyl(chloromethoxy)benzene, and allyloxy(chloromethyl)benzene. Of these, allyl chloride, which is inexpensive and highly reactive, is preferred.

Introduction of the reactive silicon group to the olefin-terminated hydrogenated polybutadiene polymer may be conducted in the same manner as with the isobutylene polymer having a reactive silicon group at the terminus of the molecular chain. For example, the polymer may be subjected to addition reaction with a hydrosilane compound having a hydrogen atom bonded to the group represented by general formula (1) above in the presence of a platinum catalyst.

A plasticizer (C) usable in the present invention is not limited and a known plasticizer can be used. Examples thereof include phthalates such as dibutyl phthalate, diheptyl phthalate, di(2-ethylhexyl) phthalate, butyl benzyl phthalate, di-n-octyl phthalate, diisononyl phthalate, diisodecyl phthalate, diundecyl phthalate; non-aromatic dibasic acid esters such as di(2-ethylhexyl) adipate, di-n-octyl adipate, diisononyl adipate, diisodecyl adipate, di(2-ethylhexyl) sebacate, di-2-ethylhexyl tetrahydrophthalate; process oil such as paraffin base oil, naphthene base oil, and aromatic base oil; fatty acid oil such as linseed oil, soybean oil, and tung oil; aromatic esters such as tri-2-ethylhexyl trimellitate and triisodecyl trimellitate; fatty acid esters such as butyl oleate, methyl acetyl ricinolate, and pentaerythritol ester; polyvinyl oligomers, such as polybutene, hydrogenated polybutene, and hydrogenated α-olefin oligomer; hydrogenated polybutadiene oligomers such as hydrogenated liquid polybutadiene; paraffins such as paraffin oil and chlorinated paraffin oil; cycloparaffin such as naphthene oil; aromatic oligomers such as biphenyl and triphenyl; completely or partially hydrogenated aromatic oligomers; sulfonate compounds such as phenyl alkyl sulfonate; and sulfonamide compounds such as toluene sulfonamide, N-ethyltoluene sulfonamide, and N-cyclohexyltoluene sulfonamide. These may be used alone or in combination.

Addition of the plasticizer (C) decreases the viscosity of the composition and improves the workability of the composition. Aromatic oligomers, completely or partially hydrogenated aromatic oligomers, sulfonate compounds, and sulfonamide compounds are preferable since they tend to notably increase the dispersion stability of the component (A) and the component (B).

When the plasticizer (C) is incorporated, the plasticizer (C) content is preferably 5 to 300 parts by weight, more preferably 10 to 150 part by weight, and most preferably 30 to 120 parts by weight per 100 parts by weight of the component (A). At a content less than 5 parts by weight, the effect of decreasing the viscosity of the composition and effect of improving the compatibility and dispersibility of the component (A) and the component (B) may become insufficient. At a content exceeding 300 parts by weight, sufficient mechanical properties may not be obtained.

If necessary, the curable composition of the present invention may include an epoxy resin (D). Incorporation of an epoxy resin increases the strength of the cured product, and the problem of rutting or the like in summer can be overcome. Examples of the epoxy resin (D) include, but are not limited to, flame-resisting epoxy resins such as epichlorohydrin-bisphenyl A-type epoxy resins, epichlorohydrin-bisphenyl F-type epoxy resins, and glycidyl ethers of tetrabromobisphenol A; novolac-type epoxy resins; hydrogenated bisphenol A-type epoxy resins; glycidyl ether epoxy resins of bisphenol A propylene oxide adducts; p-oxybenzoic acid glycidyl ether ester-type epoxy resins; m-aminophenol-type epoxy resins; diaminodiphenylmethane-type epoxy resins; urethane-modified epoxy resins; various alicyclic epoxy resins; glycidyl ethers of polyhydric alcohols, such as N,N-diglycidylaniline, N,N-diglycidyl-o-toluidine, triglycidyl isocyanulate, polyalkylene glycol diglycidyl ether, and glycerol; and epoxy compounds of unsaturated polymers such as hydantoin-type epoxy resins and petroleum resins. Any other common epoxy resins may be used. An epoxy resin having two or more epoxy groups in the molecule is preferable since it exhibits high reactivity in cure, and a three-dimensional network can be easily formed in the cured product. Bisphenol A-type epoxy resins and novolac-type epoxy resins are particularly preferable.

When the epoxy resin (D) is used, the content thereof is preferably 5 to 120 parts by weight, more preferably 5 to 100 parts by weight, and most preferably 20 to 100 parts by weight per 100 parts by weight of the component (A). At a content exceeding 120 parts by weight, the storage stability tends to be insufficient. At a content less than 5 parts by weight, the effect of improving the strength expected by the addition of the epoxy resin (D) may not be satisfactorily achieved.

When the epoxy resin (D) is added to the composition of the present invention, a curing agent may be added to promote cure of the epoxy resin. The epoxy resin curing agent usable here is not particularly limited and may be a known epoxy resin curing agent. Examples thereof include, but are not limited to, primary and secondary amines such as triethylenetetramine, tetraethylenepentamine, diethylaminopropylamine, N-aminoethyl piperidine, m-xylylenediamine, m-phenylenediamine, diaminodiphenylmethane, diaminodiphenyl sulfone, isophorone diamine, and amine-terminated polyethers; tertiary amines, such as 2,4,6-tris(dimethylaminomethyl)phenol and tripropylamine, and their salts; polyamide resins; imidazoles; dicyanediamides; carboxylic anhydrides such as boron trifluoride complex compounds, phthalic anhydride, hexahydrophthalic anhydride, tetrahydrophthalic anhydride, dodecinyl succinic anhydride, pyromellitic anhydride, and chlorendic anhydride; alcohols; phenols; carboxylic acids; and compounds such as diketone complexes of aluminum or zirconium. These curing agents can be used alone or in combination.

When the curing agent for the epoxy resin is used, the content thereof is preferably 0.1 to 300 parts by weight per 100 parts by weight of the epoxy resin.

A ketimine compound may be used as the curing agent for the epoxy resin. Ketimine compounds are stable in a water-free environment and are decomposed into primary amines and ketones by water. The primary amines thus produced can serve as room-temperature curing agents for epoxy resins. The use of the ketimine compound gives a one-component composition. The ketimine compound is obtainable by condensation reaction between an amine compound and a carbonyl compound.

The synthesis of the ketimine compound may be performed by using a known amine compound and a known carbonyl compound. Examples of the amine compound include diamines such as ethylenediamine, propylenediamine, trimethylenediamine, tetramethylenediamine, 1,3-diaminobutane, 2,3-diaminobutane, pentamethylenediamine, 2,4-diaminopentane, hexamethylenediamine, p-phenylenediamine, p,p′-biphenylenediamine; polyvalent amines such as 1,2,3-triaminopropane, triaminobenzene, tris(2-aminoethyl)amine, and tetra(aminomethyl)methane; polyalkylene polyamines such as diethylenetriamine, triethylenetriamine, and tetraethylenepentamine; polyoxyalkylene polyamines; and aminosilanes such as γ-aminopropyltriethoxysilane, N-(β-aminoethyl)-γ-aminopropyltrimethoxysilane, and N-(β-aminoethyl)-γ-aminopropylmethyldimethoxysilane. Examples of the carbonyl compound include aldehydes such as acetaldehyde, propionaldehyde, n-butylaldehyde, isobutylaldehyde, diethylacetaldehyde, glyoxal, and benzaldehyde; cyclic ketones such as cyclopentanone, trimethylcyclopentanone, cyclohexanone, trimethylcyclohexanone; aliphatic ketones such as acetone, methyl ethyl ketone, methyl propyl ketone, methyl isopropyl ketone, methyl isobutyl ketone, diethyl ketone, dipropyl ketone, diisopropyl ketone, dibutyl ketone, and diisobutyl ketone; and β-dicarbonyl compounds such as acetylacetone, methyl acetoacetate, ethyl acetoacetate, dimethyl malonate, diethyl malonate, methyl ethyl malonate, and dibenzoylmethane.

When there is an imino group in the ketimine compound, the imino group may be reacted with styrene oxide; a glycidyl ether such as butyl glycidyl ether or allyl glycidyl ether; or a glycidyl ester. These ketimine compounds may be used alone or in combination in an amount of 1 to 100 parts by weight per 100 parts by weight of the epoxy resin (D). The amount of the ketimine compound used varies depending on the type of the epoxy resin and the ketimine compound.

The curable composition of the present invention may contain a (meth)acrylic acid alkyl ester polymer (E). The term “(meth)acrylic acid alkyl ester polymer” is a polymer whose primary monomer component is a methacrylic acid alkyl ester and/or an acrylic acid alkyl ester represented by general formula (3):
CH₂═C(R⁵)COOR⁶ (3)
(wherein R⁵ is a hydrogen atom or a methyl group; and R⁶ is a C₁-C₃₀ alkyl group). The term refers to a polymer of a single monomer or a copolymer of a plurality of monomers. Incorporation of the (meth)acrylic acid alkyl ester polymer (E) in the curable composition of the present invention improves the adhesiveness and the weather resistance of the composition.

Examples of R⁶ in general formula (3) include methyl, ethyl, propyl, n-butyl, tert-butyl, 2-ethylhexyl, nonyl, lauryl, tridecyl, cetyl, stearyl, and behenyl. One or more types of monomer represented by general formula (3) may be used.

When two or more types of monomer are used, it is preferable to use a monomer (a) with R⁶ in general formula (3) representing a C₁-C₈ alkyl group and a monomer (b) with R⁶ in general formula (3) representing a C₁₀ or higher alkyl group in combination. This is because the compatibility of the curable composition can be easily controlled by adjusting the ratio between the two monomers used.

Examples of the (meth)acrylic acid alkyl ester monomer include methyl (meth)acrylate, ethyl (meth)acrylate, n-propyl (meth)acrylate, n-butyl (meth)acrylate, isobutyl (meth)acrylate, tert-butyl (meth)acrylate, n-hexyl (meth)acrylate, heptyl (meth)acrylate, 2-ethylhexyl (meth)acrylate, nonyl (meth)acrylate, decyl (meth)acrylate, undecyl (meth)acrylate, lauryl (meth)acrylate, tridecyl (meth)acrylate, myristyl (meth)acrylate, cetyl (meth)acrylate, stearyl (meth)acrylate, and behenyl (meth)acrylate.

The molecular chain of the component (E) is substantially composed of one or more types of (meth)acrylic acid alkyl ester monomer units. The phrase “substantially composed of the monomer units” means that the ratio of the (meth)acrylic acid alkyl ester monomer units in the component (E) exceeds 50 wt % and preferably is 70 wt % or more. The component (E) may additionally contain monomer units copolymerizable with the (meth)acrylic acid alkyl ester monomer units. For example, monomers having a carboxylic acid group such as (meth)acrylic acid, an amide group such as (meth)acrylamide or N-methylol(meth)acrylamide, an epoxy group such as glycidyl (meth)acrylate, or an amino group such as diethylaminoethyl (meth)acrylate or aminoethyl vinyl ether, are preferable since such copolymerization will improve hygroscopic moisture curability and in-depth curability. Other examples include monomer units derived from acrylonitrile, styrene, α-methylstyrene, alkyl vinyl ether, vinyl chloride, vinyl acetate, vinyl propionate, and ethylene.

The polymer of the component (E) may further contain a reactive silicon group represented by general formula (1) below:
—Si(R¹₃₋ₐ)Xₐ (1)
(wherein R¹ is a C₁-C₂₀ alkyl group, a C₆-C₂₀ aryl group, a C₇-C₂₀ aralkyl group, or a triorganosiloxy group represented by (R′O)₃Si—; when two R¹s are present, they may be the same or different; the three R's each represent a C₁-C₂₀ monovalent hydrocarbon group and may be the same or different; X is a hydroxyl group or hydrolyzable group; when two or more Xs are present, they may be the same or different; and a is 1, 2, or 3).

An example of the method for introducing a reactive silicon group to the polymer of the component (E) include copolymerizing a compound having both a polymerizable unsaturated bond and a reactive silicon group with a (meth)acrylic acid alkyl ester monomer unit. Examples of the compound having both a polymerizable unsaturated bond and a reactive silicon group include monomers represented by general formulae (4) and/or (5) below:
CH₂═C(R⁵)COOR⁷—Si(R¹₃₋ₐ)Xₐ (4)
(wherein R⁵ is the same as above; R⁷ is a C₁-C₆ divalent alkylene group; and R¹, X, and a are the same as above); and
CH₂═C(R⁵)—Si(R¹₃₋ₐ)Xₐ (5)
(wherein R⁵, R¹, X, and a are the same as above).

The monomers represented by general formulae (4) and/or (5) may be any known monomers. Examples thereof include γ-methacryloxypropylpolyalkoxysilanes such as γ-methacryloxypropyltrimethoxysilane, γ-methacryloxypropylmethyldimethoxysilane, and γ-methacryloxypropyltriethoxysilane; γ-acryloxypropylpolyalkoxysilanes such as γ-acryloxypropyltrimethoxysilane, γ-acryloxypropylmethyldimethoxysilane, and γ-acryloxypropyltriethoxysilane; vinylalkylpolyalkoxysilane such as vinyltrimethoxysilane, vinylmethyldimethoxysilane, and vinyltriethoxysilane.

The component (E) may be produced by a common vinyl polymerization, e.g., solution polymerization by radical reaction. The polymerization is usually conducted by adding the above-described monomers and a radical initiator, a chain transfer agent, or the like at 50° C. to 150° C. In general, the reaction product has a molecular weight distribution larger than 1.8.

Examples of the radical initiator include azo initiators such as 2,2′-azobisisobutyronitrile, 2,2′-azobis(2-methylbutyronitrile), 4,4′-azobis(4-cyanovaleric acid), 1,1′-azobis(1-cyclohexanecarbonitrile), azobisisobutyrate amidine hydrochloride, 2,2′-azobis(2,4-dimethylvaleronitrile); and organic peroxide initiators such as benzoyl peroxide and di-tert-butyl peroxide. Azo initiators are preferable since they are not affected by the solvent used for polymerization and have a smaller risk of explosion and the like.

Examples of the chain transfer agent include mercaptans such as n-dodecyl mercaptan, tert-dodecyl mercaptan, lauryl mercaptan, γ-mercaptopropyltrimethoxysilane, γ-mercaptopropylmethyldimethoxysilane, γ-mercaptopropyltriethoxysilane, and γ-mercaptopropylmethyldiethoxysilane; and halogen-containing compounds.

The polymerization may be conducted in a solvent. Preferable examples of the solvent include nonreactive solvents such as ethers, hydrocarbons, and esters.

The component (E) preferably has a number-average molecular weight of 500 to 100,000 in terms of polystyrene by GPC analysis from the standpoint of ease of handling. The component (E) more preferably has a number-average molecular weight of 1,500 to 30,000 so that the workability is high and the weather resistance of the cured product is improved.

When the component (E) is used, the ratio of the amount of (B) used to the amount of the component (E), i.e., (B)/(E), is preferably 95/5 to 10/90 and more preferably 80/20 to 60/40 on a weight basis.

The ratio of the total amount of the components (B) and (E) to the amount of the component (A) is preferably 10 to 500 parts by weight, more preferably 10 to 300 parts by weight, and most preferably 30 to 200 parts by weight per 100 parts by weight of the component (A).

A tackifier resin (F) used in the present invention is not particularly limited and any known one can be used. Examples thereof include petroleum resins such as aliphatic petroleum resins (C-5 resins), aromatic petroleum resins (C-9 resins), aliphatic/aromatic mixed petroleum resins (C-5/C-9 resins), phenol-modified C-5/C-9 resins, and dicyclopentadiene petroleum resins; rosin ester resins such as ester compounds of rosin acid, disproportionated rosin acid, or hydrogenated rosin acid with glycerol or pentaerythritol; terpene resins such as terpene resin, hydrogenated terpene resins, aromatically modified terpene resins, aromatically modified hydrogenated terpene resins, phenol-modified terpene resins (terpene phenol resins), alkylphenol-modified terpene resins; styrene resins; xylene resins such as xylene resin, phenol-modified xylene resins, and alkylphenol-modified xylene resins; phenol resins such as novolac-type phenol resins, resol-type phenol resins, alkylphenol resins, rosin-modified phenol resins, cashew oil-modified phenol resins, and tall-oil modified phenol resins; and modified resins produced by modifying these resins with epoxy resins and acryl monomers. These may be used alone or in combination as a mixture of two or more of these resins if necessary. In particular, resins modified with phenol or alkylphenol are preferably used so that the compatibility and dispersion stability between the component (A) and the component (B) can be improved.

When the component (F) is used, the amount of the component (F) used is 3 to 50 parts by weight, preferably 5 to 30 parts by weight, and most preferably 5 to 20 parts by weight per 100 parts by weight of the component (B).

If necessary, various additives, such as a silanol condensation catalyst, a filler, a thixotropic agent, and an antioxidant may be added to the curable composition of the present invention if necessary.

The silanol condensation catalyst is not particularly limited and any known one can be used. Examples thereof include silanol condensation catalysts below and other known silanol condensation catalysts such as acidic and basic catalysts. Examples of the silanol condensation catalyst include titariates such as tetrabutyl titanate and tetrapropyl titanate; organotin compounds such as dibutyltin dilaurate, dibutyltin maleate, dibutyltin diacetate, tin octylate, tin naphthenate, a reaction product of dibutyltin oxide and a phthalate, and dibutyltin bisacetylacetonate; organoaluminum compounds such as aluminum trisacetylacetonate, aluminum trisethylacetoacetate, and diisopropoxyaluminum ethylacetoacetate; chelate compounds such as zirconium tetraacetylacetonate and titanium tetraacetylacetonate; lead octylate; amine compounds such as butylamine, octylamine, dibutylamine, laurylamine, monoethanolamine, diethanolamine, triethanolamine, diethylenetriamine, triethylenetetramine, oleylamine, cyclohexylamine, benzylamine, diethylaminopropylamine, xylylenediamine, triethylenediamine, guanidine, diphenylguanidine, 2,4,6-tris(dimethylaminomethyl)phenol, morpholine, N-methylmorpholine, 2-ethyl-4-methylimidazole, 1,8-diazabicyclo[5.4.0]undecene-7, and salts of these amine compounds with carboxylic acid and the like; acidic phosphates; reaction products of acidic phosphates and amines; saturated or unsaturated polyvalent carboxylic acid or its acid anhydrides; low-molecular-weight-polyamide resins obtained from excess polyamines and polybasic acids; reaction products of excess polyamines and epoxy compounds; and amino-containing silane coupling agents such as γ-aminopropyltrimethoxysilane and N-(β-aminoethyl)-γ-aminopropylmethyldimethoxysilane. These catalysts may be used alone or in combination.

The silanol condensation catalyst is used preferably in an amount of 0.01 to 15 parts by weight and more preferably 0.1 to 10 parts by weight relative to 100 parts by weight of the component (B), or, when both the component (E) and the component (B) are used, relative to the total of 100 parts by weight of the components (B) and (E). At a part by weight less than 0.01, the curability of the composition is decreased, and at a part by weight exceeding 15, storage stability and the adhesiveness are degraded. From the standpoints of the curing rate and the storage stability, tetravalent tin catalysts are preferable.

The filler is not particularly limited, and a known filler may be used. Examples of the filler include inorganic fillers such as calcium carbonate, magnesium carbonate, titanium oxide, fly ash, silicon sand, crushed stone, gravels, carbon black, fused silica, precipitated silica, diatomaceous earth, white clay, kaolin, clay, talc, wood flour, walnut shell flour, rice husk flour, silicic acid anhydride, quartz powder, aluminum powder, zinc powder, asbestos, glass fibers, carbon fibers, glass beads, alumina, glass balloon, fly ash balloon, Shirasu balloon, silica balloon, and silicon oxide; and organic fillers such as wood fillers, e.g., pulp and cotton chips, powdered rubber, regenerated rubber, thermoplastic or thermosetting resin fine powder, and hollow substances such as polyethylene. These fillers may be used alone or in combination.

The filler is preferably used in an amount of 50 to 1,000 parts by weight and more preferably 60 to 900 parts by weight per 100 parts by weight of the component (B). At a filler content less than 50 parts by weight, the purpose of using the filler may not be fulfilled. At a content exceeding 1,000 parts by weight, the viscosity may increase and the workability may be degraded. Fly ash balloon and calcium carbonate are particularly preferred as the filler.

The thixotropic agent is not particularly limited and may be a known one. Examples thereof include hydrogenated castor oil, organic amide wax, organic bentonite, and calcium stearate. These thixotropic agents may be used alone or in combination.

The thixotropic agent is preferably used in an amount of 0.1 to 50 parts by weight and more preferably 1 to 30 parts by weight per 100 parts by weight of the component (B). When the thixotropic agent is used in an amount less than 0.1 part by weight, sufficient thixotropy may not be obtained. At an amount exceeding 50 parts by weight, the cost increases.

The age resistor is not particularly limited, and a known age resistor may be used. Examples thereof include phenol antioxidants, aromatic amine antioxidants, sulfur antioxidant, phosphorus antioxidants, benzotriazole UV absorbers, salicylate UV absorbers, benzoate UV absorbers, benzophenone UV absorbers, hindered amine photostabilizers, and nickel photostabilizers.

The age resistor is preferably used in an amount of 0.01 to 20 parts by weight and more preferably 0.1 to 10 parts by weight per 100 parts by weight of the component (B).

Examples of the phenol antioxidants include 2,6-di-tert-butylphenol, 2,4-di-tert-butylphenol, 2,6-di-tert-butyl-4-methylphenol, 2,5-di-tert-butylhydroquinone, n-octadecyl-3-(3,5-di-tert-butyl-4-hydroxyphenyl) propionate, pentaerythrityl-tetrakis[3-(3,5-di-tert-butyl-4-hydroxyphenyl) propionate], 2,2′-methylenebis(4-methyl-6-tert-butylphenol), 4,4′-butylidenebis(3-methyl-6-tert-butylphenol), and 4,4′-thiobis(3-methyl-6-tert-butylphenol).

Examples of the aromatic amine antioxidants include N,N′-diphenyl-p-phenylenediamine and 6-ethoxy-2,2,4-trimethyl-1,2-dihydroquinoline.

Examples of the sulfur antioxidants include dilauryl-3,3′-thiodipropionate, ditridecyl-3,3′-thiodipropionate, and distearyl-3,3′-thiodipropionate.

Examples of the phosphorus antioxidants include diphenyl isooctyl phosphite and triphenyl phosphite.

Examples of the benzotriazole UV absorbers include 2-(3,5-di-tert-butyl-2-hydroxyphenyl)-5-chlorobenzotriazole, 2-(3-tert-butyl-5-methyl-2-hydroxyphenyl)-5-chlorobenzotriazole, 2-(3,5-di-tert-butyl-2-hydroxyphenyl)benzotriazole, and 2-(5-methyl-2-hydroxyphenyl)benzotriazole.

Examples of the salicylate UV absorbers include 4-tert-butylphenyl salicylate.

Examples of the benzoate UV absorbers include 2,4-di-tert-butylphenyl-3,5-di-tert-butyl-4-hydroxybenzoate.

Examples of the benzophenone UV absorbers include 2,4-dihydroxybenzophenone, 2-hydroxy-4-methoxybenzophenone, 2-hydroxy-4-n-octoxybenzophenone, 2-hydroxy-4-n-dodecyloxybenzophenone, and 2-hydroxy-4-benzyloxybenzophenone.

Examples of the hindered amine photostabilizer include bis(2,2,6,6,-tetramethyl-4-piperidyl) sebacate, bis(1,2,2,6,6,-pentamethyl-4-piperidyl) sebacate, 1-{2-[3-(3,5-di-tert-butyl-4-hydroxyphenyl)propionyloxy)]ethyl}-4-[3-(3,5-di-tert-butyl-4-hydroxyphenyl)propionyloxy]-2,2,6,6,-tetramethylpiperidine, and 4-benzoyloxy-2,2,6,6,-tetramethylpiperidine.

Examples of the nickel photostabilizer include nickel dibutyldithiocarbamate, [2,2′-thiobis(4-tert-octylphenolate)]-2-ethylhexylamine nickel (II), and [2,2′-thiobis(4-tert-octylphenolate)]-n-butylamine nickel (II).

These age resistors may be used alone or in combination. In some cases, a combination of two or more of these age resistors functions more effectively compared to when the age resistors are used alone.

The curable composition of the present invention may be applicable to sealing materials, adhesives, pressure-sensitive adhesives, injection materials, waterproof materials, damping materials, and sound insulating materials in various fields including civil engineering, construction, and industrial uses.

In particular, the curable composition of the present invention is applicable to interior and exterior walls, floors, various concretes, sealing for metal joints, marine sealants, pool joint sealant, ant-proof sealants, floor materials, wall materials, roofing material adhesives, adhesives for tiles on interior and exterior walls, stones, and decoration panels, sealing adhesives for clay pipes, man-holes, cables and the like, potting materials, various pressure-sensitive adhesives, pavement materials for general road, highways, and airport runaways, repairing materials, joint sealing materials, waterproof materials for basements of buildings and multilevel car parking, roof waterproofing materials, roof coating materials, and damping and sound insulating materials for vehicles, ships, and home electric appliances.

The curable composition of the present invention is particularly suitable for applications to tile adhesives, waterproof materials, road paving materials, water stopping materials for civil engineering, and damping materials, among these applications. Applications to waterproof materials, tile adhesives, road paving materials, water stopping materials for civil engineering, and damping materials are described below.

<Waterproof Material>

The mainstream of the waterproofing work is hot processes for asphalt waterproofing in which the step of melting blown asphalt at the construction site to bond asphalt roofing is repeated three to four times to form a waterproofing layer. Another example of the waterproofing work includes heating the rear side of an asphalt roofing sheet with a special torch burner so that the sheet can be fixed onto the base material while melting the asphalt applied on the rear side. A cold (adhesive) process in which an asphalt roofing sheet is fixed on the base material with an adhesive applied to the rear side and a bonding process in which an asphalt roofing sheet is fixed onto the base material with an asphalt-based adhesive are also available. However, the hot process for asphalt waterproofing has high waterproofing reliability (adhesion to the base material) and thus has been the mainstream of the waterproofing work.

However, the hot process for asphalt waterproofing has problems in that large amounts of fumes and odor are generated by melting the asphalt and significantly contaminate the surrounding environment. Thus, the hot process has been avoided in thickly housed areas and central urban areas, and the area that can use the hot process has been limited. Moreover, workers face dangers of burn injury and thus tend to avoid the hot process.

In order to overcome these problems, prior to the bonding of the asphalt roofing sheets, a cut-back asphalt prepared by diluting asphalt with a solvent is used as the primer to improve the adhesion to the base material. However, evaporation of the solvent significantly contaminates the surrounding environment.

In contrast, a waterproof material incorporating the curable composition of the present invention does not generate asphalt fumes or odor or solvent odor during the working. Sufficient room temperature curability is exhibited, and satisfactory waterproof adhesiveness to mortar is achieved. Thus, the waterproof material incorporating the curable composition of the present invention is effective as a waterproof material, an adhesive for asphalt roofing sheets, and a primer.

<Tile Adhesives>

Tile adhesives are used in bonding tiles onto walls of buildings, bathrooms, toilets, kitchens, etc. Specific examples of the adherends include inorganic base materials such as cement mortars, calcium silicate boards, cement boards, ALC boards, and ceramic siding boards; and wood base materials such as plywood laminates. Examples of the tiles include earthenware tiles, ceramic tiles and stoneware tiles.

The major process for bonding tiles has been a direct bonding method in which tiles are bonded using balls of cement mortar. In recent years, this method has been mostly replaced with a bonding method that uses organic adhesives. The tile adhesives are roughly divided into aqueous adhesives and reactive adhesives and are selected according to the usage. Aqueous tile adhesives have deficient waterproofing property since the base resin of the aqueous tile adhesives is an aqueous emulsion incorporating a surfactant in most cases. Moreover, aqueous tile adhesives generate odor resulting from the organic solvent used to dissolve the tackifier resin or the like, are inflammable, and give adverse effects to human bodies. Reactive tile adhesives are typically urethane resin-based or epoxy resin-based. Urethane resin-based reactive tile adhesives have problems of irritation caused by isocyanate in the system, of harmful organic solvents, and of adverse effects on human bodies. Epoxy resin-based reactive tile adhesives have problems of irritation caused by amine curing agents, hazardous organic solvent, and adverse effects on human bodies.

Furthermore, the epoxy resin-based adhesives cannot absorb the strain caused by external force and may cause detachment of tiles by vibration due to earthquake. In order to overcome these problems, one approach disclosed in Japanese Unexamined Patent Application Publication No. 06-101319 provides adding a rubber organic polymer or a modified silicone compound. The description reported that the brittleness of the cured products of epoxy resins was improved, thereby obtaining flexible cured products. However, this approach does not provide satisfactory waterproof adhesiveness when design materials, such as tiles and stones, frequently come into contact with water, since the tiles and stones tend to detach from the base in such positions.

In contrast, a tile adhesive incorporating the curable composition of the present invention shows excellent waterproof adhesiveness, in particular alkaline waterproof adhesiveness, and is usable without any solvent. Thus, no problem of odor, inflammability, or adverse effects on human bodies occurs.

<Road Paving Material>

In using asphalt as the road paving material, hot asphalt paving has been generally employed. The hot asphalt paving has problems of generation of large amounts of fumes and odor of hot asphalt that significantly contaminate the surrounding environment. Moreover, hot asphalt paving has insufficient elasticity and adhesiveness, and the road surface becomes fluidized as the temperature increases in summer, thereby causing cracks and sticky surfaces. In winter, caking power of the aggregates in the asphalt paving material decreases, thereby causing deterioration in the surface layers of the asphalt paving and cracks and separation due to difference in temperature.

In contrast, with the road paving material incorporating the curable composition of the present invention, paving and maintenance can be performed without generating fumes or odor.

In using the curable composition of the present invention as the road paving material, it is preferable to blend aggregates to increase the reinforcing property.

The aggregates are preferably coarse aggregates, fine aggregates, or fillers used in asphalt paving. The coarse aggregates are generally crushed stone, but may be crushed cobble, gravel, or slag. The fine aggregates are generally sand such as river sand, sea sand, or mountain sand but may be iron sand or screenings from crushed stone. Light-colored aggregates and hard aggregates are also usable. The filler is generally powdered stone prepared by crushing limestone or igneous rocks but may be powder of other rocks, calcium carbonate powder, caustic lime, plaster, fly ash, fly ash balloon, cement, or incinerated ash. Carbon black and pigments are also usable. Moreover, the filler may partly contain short fibers such as asbestos, glass fibers, rock wool, synthetic fibers, or carbon fibers, or mica powder.

<Water Stopping Material for Civil Engineering>

In the fields of civil engineering and construction, boats and ships, and automobiles, various sealing materials are used to fill the joint or cracked part to provide water sealing or air sealing. Sealing materials containing reactive silicon group-containing organic polymers are widely used from the standpoint of the weather resistance, curability, and workability (for example, refer to Japanese Unexamined Patent Application Publication No. 08-003537). However, the organic polymers used as the sealing materials do not per se have sufficient waterproofing property. Thus, for example, when they are immersed in water for a long time, permeation of water and a decrease in adhesion interfacial force are observed, and sufficient water stopping property and adhesiveness are not obtained. These sealing materials do not have sufficient weather resistance and undergo cracking or the like in the surface or inside once they are exposed to outdoor environment, thereby failing to achieve sufficient water stopping property and adhesiveness.

In contrast, a water stopping material incorporating the curable composition of the present invention has excellent weather resistance, waterproofing property, and adhesiveness.

<Damping Material>

Damping materials are used in vehicles, buildings, home electric appliances, and the like.

Damping materials are directly or indirectly bonded to a vibration generating source to control the vibration and thereby achieve sound insulation. For example, damping materials are used in steel boards such as dash panels that separate the vehicle interior from the engine room, floors, and trunk rooms; building structures such as floors of each house of a condominium building; and home electric appliances that generate noise, such as air conditioners, compressors, and vacuum cleaners.

In order to bond an asphalt sheet onto a floor line of an automobile so that the asphalt sheet can function as a damping sheet, it is necessary to melt the asphalt by heating. Thus, the thermal fluidity has been a problem, i.e., it has been difficult to uniformly maintain the thickness of the sheet. As a result, there have been technical problems of nonuniform damping effects, poor fitting to irregularities of the base material, and thus failure of achieving close and uniform thermal bonding to the base material. In order to overcome these problems, a technique of mixing a fibrous filler to a sheet base material has been disclosed (e.g., Japanese Unexamined Patent Application Publication No. 07-323791). However, this technique does not satisfy the requirements of the properties since it requires thermal bonding of asphalt. Moreover, a cold curing process is desired to increase the efficiency of working and to improve the adhesion to the irregularities.

In contrast, a damping material incorporating the curable composition of the present invention has excellent workability, causes no dilation during working, and exhibits excellent adhesiveness to irregularities.

### EXAMPLES

The present invention will now be described in further details below by way of nonlimiting examples.

### Synthetic Example 1

A three-way cock was mounted on a 2 L pressure glass container, and the container was purged with nitrogen. Using an injection syringe, 270 ml of ethylcyclohexane dried over molecular shieves 3A, 630 ml of toluene dried over molecular sieves 3A, and 5.80 g (25.1 mmol) of p-dicumyl chloride were added.

Next, a pressure glass liquid-collecting tube equipped with a needle valve and charged with 280 ml of an isobutylene monomer was connected to the three-way cock. The polymerization container was cooled in a −70° C. dry ice/ethanol bath and vacuumed with a vacuum pump. The needle valve was opened to introduce the isobutylene monomer from the liquid-collecting tube into the polymerization container, and then nitrogen was introduced from one port of the three-way cock to return the pressure inside the container to normal. Subsequently, 0.465 g (5.0 mmol) of 2-methylpyridine was added, and then 8.25 ml (75.5 mmol) of titanium tetrachloride was added to initiate polymerization. Seventy minutes after the initiation of polymerization, 6.10 g (54.0 mmol) of allyltrimethylsilane was added to introduce an allyl group to a polymer terminus. One hundred and twenty minutes after the initiation of the polymerization, the reaction solution was washed with 200 ml of water four times, and the solvent was distilled off to obtain an allyl-terminated isobutylene polymer.

Next, 400 g of the resulting allyl-terminated isobutylene polymer was combined with 120 g of process oil, i.e., a hydrocarbon plasticizer, Diana Process Oil PS-32 produced by Idemitsu Kosan Co., Ltd. The resulting mixture was heated to about 75° C., and 1.5 [eq/vinyl] of methyldimethoxysilane and 1×10⁻⁴ [eq/vinyl] of a platinum(vinylsiloxane) complex were added to the mixture to conduct hydrosilylation. The reaction was tracked with a Fourier transform infrared spectrophotometer (FT-IR), i.e., IR-408 produced by Shimadzu Corporation, and an olefin absorption at 1,640 cm⁻¹ was lost in about 20 hours (polymer A: 77% concentration).

The resulting polymer A was analyzed by gel permeation chromatography (GPC) to determine Mn and Mw/Mn and analyzed by ¹H-NMR to determine the percentage of functionalized termini. In the latter analysis, the intensity of the resonance signal of a proton assigned to each structure (the proton attributable to the initiator: 6.5 to 7.5 ppm; the methyl proton bonded to the silicon atom and attributable to the polymer termini: 0.0 to 0.1 ppm; and methoxy proton: 3.4 to 3.5 ppm) was measured, and the results were compared. The ¹H-NMR analysis was conducted with Varian Gemini 300 (300 MHz) in CDCl₃. With respect to GPC, Waters LC Module 1 was used as the delivery system with a Shodex K-804 column. The analysis of the polymer reported Mn=11,400 and Mw/Mn=1.23, and the number of terminal silyl groups (Fn(silyl)) was 1.76. The number-average molecular weight was determined as polystyrene equivalent, and the number of the terminal silyl groups was per molecule of the isobutylene polymer.

### Synthetic Example 2

An allyl-terminated isobutylene polymer was prepared as in SYNTHETIC EXAMPLE 1 but with 262.5 ml of ethylcyclolhexane, 787.5 ml of toluene, 438 ml (5.15 mol) of isobutylene monomer, 4.85 g (21.0 mmol) of p-dicumyl chloride, 0.72 g (7.7 mmol) of 2-methylpiridine, and 7.20 g (63.0 mmol) of allyltrimethylsilane.

Subsequently, 400 g of the resulting allyl-terminated isobutylene polymer was combined with 200 g of Diana Process Oil PS 32, and the resulting mixture was heated to about 75° C. Then, 1.5 [eq/vinyl] of methyldimethoxysilane and 1×10⁻⁴ [eq/vinyl] of a platinum(vinylsiloxane) complex were added to conduct hydrosilylation. The reaction was tracked with FT-IR, and an olefin absorption at 1,640 cm⁻¹ was lost in about 20 hours (polymer B: 67% concentration).

The analysis of the polymer B reported Mn=17,600, Mw/Mn=1.23, and Fn(silyl)=1.96.

### Synthetic Example 3

Using a 1/1 (weight basis) mixture of polyoxypropylene diol having a number-average molecular weight of 2,000 and polyoxypropylene triol having a number-average molecular weight of 3,000 as an initiator, propylene oxide was polymerized in the presence of a zinc hexacyanocobaltate-glyme complex catalyst to obtain polypropylene oxide having a number-average molecular weight of 22,000 (polystyrene equivalent determined by GPC). The resulting polypropylene oxide was reacted with sodium methoxide and then with allyl chloride to convert the terminal hydroxyl groups to unsaturated groups. To one mole of the unsaturated group of an unsaturated group-terminated polyoxyalkylene, 0.72 mol of dimethoxymethylsilane was reacted in the presence of chloroplatinic acid to obtain a polyoxypropylene polymer (polymer C) having a number-average molecular weight of 22,200 and 70% of molecular termini occupied by dimethoxymethylsilyl groups (¹H-NMR analysis)

### Synthetic Example 4

Using polyoxypropylene diol having a number-average molecular weight of 2,000 as the initiator, propylene oxide was polymerized in the presence of a zinc hexacyanocobaltate-glyme complex catalyst to obtain polyoxypropylene glycol having a number-average molecular weight of 26,000 (polystyrene equivalent by GPC). The resulting polypropylene glycol was reacted with sodium methoxide and then with allyl chloride to convert the terminal hydroxyl groups to unsaturated groups. To one mole of the unsaturated group of the unsaturated group-terminated polyoxyalkylene polymer, 0.77 mole of a hydrosilane compound represented by HSi (CH₃) (CH₃) OSi (CH₃) (CH₃) CH₂CH₂Si (OCH₃)₃ was reacted in the presence of chloroplatinic acid to obtain a polyoxypropylene polymer (polymer D) having a number-average molecular weight of 26,300 and 75% of molecular termini occupied by the trimethoxysilyl groups.

### Synthetic Example 5

To a pressure reactor equipped with a stirrer, 800 g of polyoxypropylene glycol having a number-average molecular weight of 5,200 and 50.2 g of isophorone diisocyanate were added and mixed. To the resulting mixture, 0.8 g of a tin catalyst (a 10% DOP solution of dibutyltin dilaurate) was added. The resulting mixture was stirred for 4 hours at 80° C. to obtain an isocyanato group-terminated polymer having a number-average molecular weight of 15,000. The molecular weight here was determined from the titer (0.579%) of the isocyanato groups. The polymer was cooled to 60° C. and combined with 1.0 [eq/NCO] of γ-aminopropyltrimethoxysilane. The resulting mixture was stirred for about 30 minutes to obtain a polyoxypropylene polymer (polymer E) having a number-average molecular weight of 17,000 (polystyrene equivalent by GPC) and trimethoxysilyl groups at the molecular termini.

The materials used in EXAMPLES were as follows:

Component (A)

Straight asphalt (1): straight asphalt 60 to 80 (produced by Cosmo Oil Co., Ltd.)

Straight asphalt (2): straight asphalt 150 to 200 (produced by Cosmo Oil Co., Ltd.)

Blown asphalt: blown asphalt 20 to 30 (produced by Cosmo Oil Co., Ltd.)

Cut-back asphalt: blown asphalt 20 to 30 diluted with toluene (solid content: 60%)

Component (B)

Polymer A or B obtained by the above-described synthesis.

Component (C)

Mesamoll: alkylsulfonic phenyl ester (produced by Bayer)

Mesamoll II: alkylsulfonic phenyl ester (produced by Bayer)

AC-12: Diana Process Oil AC-12 (produced by Idemitsu Kosan Co., Ltd.)

HB-40; partially hydrogenated terphenyl (produced by Solutia Inc.)

Topcizer No. 3: N-ethyl-o/p-toluenesulfonamide (produced by Fuji Amide Chemical Co., Ltd.)

Component (D)

Epikote 828: epoxy resin (Japan Epoxy Resins Co., Ltd.)

Component (F)

PM-100: phenol-modified C-5/C-9 petroleum resin (produced by Toho Chemical Industry Co., Ltd.)

HP-70: alkylphenol-modified xylene resin (produced by Fudow Corporation)

YS Polyster T-30: phenol-modified terpene resin (produced by Yasuhara Chemical Co., Ltd.)

Mightyace G-125: phenol-modified terpene resin (produced by Yasuhara Chemical Co., Ltd.)

(Block Copolymer)

SBS: styrene/butadiene/styrene block copolymer

(Rubber Component)

SBR: styrene/butadiene rubber

(Silane Coupling Agent)

A-1310: γ-isocyanatopropyltriethoxysilane (produced by Dow Corning Toray Silicone Co., Ltd.)

A-171: vinyltrimethoxysilane produced by Dow Corning Toray Silicone Co., Ltd.)

A-187: γ-glycidoxypropyltrimethoxysilane (produced by Dow Corning Toray Silicone Co., Ltd.)

A-1120: N-(β-aminoethyl)-γ-aminopropyltrimethoxysilane (produced by Dow Corning Toray Silicone Co., Ltd.)

(Filler)

Whiton SB (calcium carbonate produced by Shiraishi Calcium Kaisha Ltd.)

Fly ash balloon: fine, hollow spherical particles (alumina silicate produced by Tokai Kogyo)

Sepiolite S: magnesium silicate (produced by Nippon Talc Co., Ltd.)

Silica sand: produced by Maruo Calcium Co.

Talc: Microace P4 (average particle diameter: 4.5 μm produced by Nippon Talc Co., Ltd.)

Aggregate

(Curing Catalyst)

SCAT-1: organotin compound (produced by Sankyo Organic Chemicals Co., Ltd.)

SCAT-27: organotin compound (produced by Sankyo Organic Chemicals Co., Ltd.)

(Curing Aid)

Water

Zeolite 4A

(Epoxy Resin Curing Agent)

H-30: ketimine curing agent (produced by Japan Epoxy Resins Co., Ltd.)

(Antioxidant)

Irganox 245: hindered phenol antioxidant (produced by Ciba Specialty Chemicals)

(UV Absorber)

Tinuvin 213: benzotriazole UV absorber (produced by Ciba Specialty Chemicals)

(Photostabilizer)

Sanol LS765: hindered amine photostabilizer (produced by Sankyo Co., Ltd.)

(Evaluation of Physical Properties)

The evaluation was conducted on the following items:

<Odor>

Whether the solvent odor or asphalt fumes or odor is generated during application of the composition was determined. A rating “good” was given when no odor or fume was generated. A rating “poor” was given when odor and/or fume was generated.

<Curability>

After the application of the composition, the surface was sequentially touched with a spatula, and the time required until the composition no longer stuck onto the spatula was measured (23° C. and 50% RH). A rating “good” was given when the surface cured within 30 minutes, and rating “poor” was given otherwise.

<Storage Stability>

The curable composition was enclosed air tight and left to stand at 50° C. for 30 days. The state of separation was evaluated. A rating “good” was given when no separation was observed, and a rating “poor” was given when separation occurred.

<Waterproof Adhesiveness>

The composition in a bead form was applied onto a mortar base material and aged at 23° C. and 50% RH for seven days. Subsequently, the mortar base material was immersed in water at 23° C. for seven days. Immediately after the mortar base material was taken out of the water, a cut line was made with a cutter between the cured product and the mortar to separate the cured product. The state of adhesion was observed. A rating “good” was given when the adhesive remained on the mortar side, and a rating “poor” was given otherwise.

Mortar: 50×50×15 [mm], produced by Engineering Test Service

<Weather Resistance Testing>

A sheet having a thickness of 3 mm was formed from the curable composition and left to stand at 23° C. for three days. The resulting sheet was heated at 50° C. for four days to obtain a rubbery sheet. The rubbery sheet was placed on an aluminum plate having a thickness of 1 mm and set on a sunshine weatherometer (produced by Suga Test Instruments Co., Ltd.) to evaluate the weather resistance. A rating “good” was given when no deterioration occurred before 1,000 hours of sunshine, and a rating “poor” was given when deterioration occurred by this time.

<Workability>

The viscosity of the composition was measured using a BH viscometer (rotor: No. 7, revolution: 10 rpm, temperature: 23° C.). A rating “good” was given when the viscosity was 500 Pa·s or less and “poor” was given when the viscosity was more than 500 Pa·s.

<Tile Bonding Test>

An adhesive was applied onto a mortar board 70×70×20 mm in size and flattened uniformly with a tooth trowel. A 45×45×7 mm ceramic tile was bonded thereto and left for seven days (23° C. and 50% RH). A tension jig was attached onto the tile surface of a specimen with an epoxy adhesive, and tensile testing was conducted using an autograph (speed of testing: 5 mm/min). The specimen was immersed in 60° C. hot water and a 60° C. saturated aqueous solution of calcium hydroxide for seven days. The tensile test was performed immediately after the specimen was taken out of the solution to determine the waterproofing bonding strength. The ratio of the bonding strength after immersion in the 60° C. hot water and that after immersion in the 60° C. calcium hydroxide saturated aqueous solution were determined as the waterproof retaining ratio and the alkali-proof retaining ratio.

### Examples 1 to 7 and Comparative Examples 1 and 2

Each blend having a composition shown in Table 1 was mixed and kneaded in a 5 L mixer to prepare curable compositions of EXAMPLES 1 to 7 and COMPARATIVE EXAMPLES 1 and 2.

The results are shown in Table 1

TABLE 1

| | | | EX. 1 | EX. 2 | EX. 3 | EX. 4 | EX. 5 | EX. 6 | EX. 7 | C. EX. 1 | C. EX. 1 |
|---|---|---|---|---|---|---|---|---|---|---|---|
| Main | Component (A) | Straight | 70 | 50 | 70 | 70 | 70 | 70 | 70 | | |
| ingredient | | asphalt (1) | | | | | | | | | |
| | | Blown | | | | | | | | 100 | |
| | | asphalt | | | | | | | | | |
| | | Cut-back | | | | | | | | | 100 |
| | | asphalt | | | | | | | | | |
| | Component (B) | Polymer A | 65 | 65 | | 65 | 65 | 65 | 65 | | |
| | | Polymer B | | | 75 | | | | | | |
| | Block copolymer | SBS | | | | | | | | 10 | 10 |
| | Component (C) | Mesamoll | 40 | 40 | 50 | 40 | 40 | 40 | | | |
| | | AC-12 | 10 | 10 | 20 | 10 | 10 | 10 | | | |
| | | Topcizer | | | | | | | 50 | | |
| | | No. 3 | | | | | | | | | |
| | Component (F) | PM-100 | 5 | 5 | 5 | | | | 5 | | |
| | | HP-70 | | | | 5 | | | | | |
| | | T-30 | | | | | 5 | | | | |
| | | G-125 | | | | | | 5 | | | |
| | Silane coupling | A-1310 | 3 | 3 | 3 | 3 | 3 | 3 | 3 | | |
| | agent | A-187 | 2 | 2 | 2 | 2 | 2 | 2 | 2 | | |
| | Filler | Whiton SB | 140 | 100 | 190 | 140 | 140 | 140 | 140 | 100 | 100 |
| | | Fly ash | 50 | 90 | | 50 | 50 | 50 | 50 | 100 | 100 |
| | | balloon | | | | | | | | | |
| | Component (C) | AC-12 | 15 | 15 | 15 | 15 | 15 | 15 | 15 | | |
| Curing agent | Curing catalyst | SCAT-27 | 2 | 2 | 2 | 2 | 2 | 2 | 2 | | |
| | Filler | Whiton SB | 10 | 10 | 10 | 10 | 10 | 10 | 10 | | |
| | Curing aid | Zeolite 4A | 3 | 3 | 3 | 3 | 3 | 3 | 3 | | |
| | | Water | 2 | 2 | 2 | 2 | 2 | 2 | 2 | | |
| Evaluation | Odor | | Good | Good | Good | Good | Good | Good | Good | Not good | Not good |
| results | Curability | | Good | Good | Good | Good | Good | Good | Good | Good | |
| | Storage stability | | Good | Good | Good | Good | Good | Good | Good | Not good | Good |
| | Waterproof | | Good | Good | Good | Good | Good | Good | Good | Not good | Not good |
| | adhesiveness | | | | | | | | | | |

EX. = EXAMPLE,
C. EX = COMPARATIVE EXAMPLE

The curable compositions of the present invention generated no asphalt fume or odor or solvent odor during working, and exhibited satisfactory room temperature curability and satisfactory waterproof adhesiveness to the mortar. The dispersion stability was also satisfactory. In COMPARATIVE EXAMPLES, no system achieving a good balance between these properties was observed.

### Example 8 and Comparative Examples 3 to 6

### Comparison of Performance as Tile Adhesives

Each blend having a composition shown in Table 2 was mixed and kneaded in a 5 L mixer to prepare adhesives of EXAMPLE 8 and COMPARATIVE EXAMPLES 3 to 6.

The results of the evaluation are shown in Table 2

TABLE 2

| | | EX. 8 | C. EX. 3 | C. EX. 4 | C. EX. 5 | C. EX. 6 |
|---|---|---|---|---|---|---|
| Component (A) | Straight asphalt | 50 | | | | |
| | (2) | | | | | |
| Component (B) | Polymer A | 130 | 130 | | | |
| | Polymer C | | | 100 | | |
| | Polymer D | | | | 100 | |
| | Polymer E | | | | | 100 |
| Component (C) | Mesamoll II | 40 | 80 | 40 | 20 | 20 |
| | HB-40 | | | | 20 | 20 |
| Component (D) | Epikote 828 | 10 | 10 | 10 | 10 | 10 |
| Component (F) | PM-100 | 10 | | | | |
| Silane coupling | A-171 | | | 1 | 1 | 1 |
| agent | A-1310 | 3 | 3 | | | |
| | A-187 | 3 | 3 | 3 | 3 | 3 |
| Filler | Whiton SB | 200 | 200 | 200 | 200 | 200 |
| | Sepiolite S | 5 | 5 | 5 | 5 | 5 |
| | Silica sand | 100 | 100 | 100 | 100 | 100 |
| Curing catalyst | SCAT-1 | | | 1 | 1 | 1 |
| | SCAT-27 | 2 | 2 | | | |
| Epoxy resin | Epicure H-30 | 5 | 5 | 5 | 5 | 5 |
| curing agent | | | | | | |
| Curing aid | Water | 2 | 2 | | | |
| | Zeolite 4A | 3 | 3 | | | |
| Tile bonding | Original state | 1.5 | 1.2 | 1.4 | 1.5 | 1.3 |
| strength | (MPa) | | | | | |
| | After immersion | 1.3 | 0.8 | 0.9 | 1.0 | 0.8 |
| | in water (MPa) | | | | | |
| | After immersion | 1.1 | 0.5 | 0.6 | 0.7 | 0.6 |
| | in alkali (MPa) | | | | | |
| | Waterproof | 87 | 67 | 64 | 67 | 62 |
| | retaining ratio | | | | | |
| | (%) | | | | | |
| | Alkali-resistance | 73 | 42 | 43 | 47 | 46 |
| | retaining ratio | | | | | |
| | (%) | | | | | |

EX. = EXAMPLE,
C. EX = COMPARATIVE EXAMPLE

EXAMPLE 8 showed satisfactory bonding strength after the immersion in water and after the immersion in the calcium hydroxide aqueous solution, thereby demonstrating sufficient adhesiveness and durability. In contrast, although COMPARATIVE EXAMPLES exhibited sufficient bonding strength in original state, the bonding strength decreased significantly by the immersion in water.

### Example 9 and Comparative Examples 7 to 9

### Comparison of Performance as Waterproofing Agent

Each blend having a composition shown in Table 3 was mixed and kneaded in a 5 L mixer to prepare waterproofing agents of EXAMPLE 9 and COMPARATIVE EXAMPLES 7 to 9.

The results of evaluation are shown in Table 3

TABLE 3

| | | EX. 9 | C. EX. 7 | C. EX. 8 | C. EX. 9 |
|---|---|---|---|---|---|
| Component (A) | Straight | 140 | 20 | | |
| | asphalt (2) | | | | |
| | Blown | | 80 | 100 | |
| | asphalt | | | | |
| | Cut-back | | | | 100 |
| | asphalt | | | | |
| Component (B) | Polymer A | 130 | | | |
| Component (C) | Mesamoll II | 50 | | | |
| | HB-40 | | | | |
| Component (F) | PM-100 | 10 | | | |
| Block | SBS | | 10 | 10 | 10 |
| copolymer | | | | | |
| Silane coupling | A-1310 | 3 | | | |
| agent | | | | | |
| Filler | Calcium | 200 | 200 | 200 | 200 |
| | carbonate | | | | |
| Curing catalyst | SCAT-27 | 2 | | | |
| Epoxy resin | Epicure | | | | |
| curing agent | H-30 | | | | |
| Curing aid | Water | 2 | | | |
| | Zeolite 4A | 3 | | | |
| Workability | | Good | Not good | Not good | Not good |
| Odor | | Good | Not good | Not good | Not good |
| Curability | | Good | Good | Good | Not good |
| Storage | | Good | Not good | Not good | Good |
| stability | | | | | |

EX. = EXAMPLE,
C. EX = COMPARATIVE EXAMPLE

The waterproofing composition of EXAMPLE 9 generated no asphalt fume or odor or solvent odor during working, and had low viscosity, satisfactory workability, and sufficient room-temperature curability. The storage stability thereof was also satisfactory. In contrast, no system that achieves a good balance between these properties was found in COMPARATIVE EXAMPLES.

### Example 10 and Comparative Examples 10 to 13

### Comparison of Performance as Sealing Material Composition

Each blend having a composition shown in Table 4 was mixed and kneaded in a 5 L mixer to prepare sealing material compositions of EXAMPLE 10 and COMPARATIVE EXAMPLES 10 to 13.

The results of evaluation are shown in Table 4.

TABLE 4

| | | EX. 10 | C. EX. 10 | C. EX. 11 | C. EX. 12 | C. EX. 13 |
|---|---|---|---|---|---|---|
| Component (A) | Straight asphalt | 50 | | | | |
| | (2) | | | | | |
| Component (B) | Polymer A | 130 | 130 | | | |
| | Polymer C | | | 100 | | |
| | Polymer D | | | | 100 | |
| | Polymer E | | | | | 100 |
| Component (C) | Mesamoll II | 40 | 80 | 40 | 20 | 20 |
| | HB-40 | | | | 20 | 20 |
| Component (F) | PM-100 | 10 | | | | |
| Silane coupling | A-171 | | | 1 | 1 | 1 |
| agent | A-1120 | | | 2 | 2 | 2 |
| | A-1310 | 3 | 3 | | | |
| Filler | Whiton SB | 200 | 200 | 200 | 200 | 200 |
| Antioxidant | Irganox 245 | 1 | 1 | 1 | 1 | 1 |
| UV absorber | Tinuvin 213 | 1 | 1 | 1 | 1 | 1 |
| Photostabilizer | Sanol LS 765 | 1 | 1 | 1 | 1 | 1 |
| Curing catalyst | SCAT-1 | | | 1 | 1 | 1 |
| | SCAT-27 | 2 | 2 | | | |
| Curing aid | Water | 2 | 2 | | | |
| | Zeolite 4A | 3 | 3 | | | |
| Weather | | Good | No good | No good | No good | No good |
| resistance | | | | | | |
| Waterproof | | Good | No good | No good | No good | No good |
| adhesiveness | | | | | | |

EX. = EXAMPLE,
C. EX = COMPARATIVE EXAMPLE

The sealing material composition of EXAMPLE 10 showed satisfactory waterproof adhesiveness and weather resistance, but none of COMPARATIVE EXAMPLES showed satisfactory results.

### Example 11 and Comparative Examples 14 to 16

### Comparison of Performance as Damping Material

Each blend having a composition shown in Table 5 was mixed and kneaded in a 5 L mixer to prepare sealing material compositions of EXAMPLE 11 and COMPARATIVE EXAMPLES 14 to 16.

The results of evaluation are shown in Table 5.

TABLE 5

| | | EX. 11 | C. EX. 14 | C. EX. 15 | C. EX. 16 |
|---|---|---|---|---|---|
| Component (A) | Straight asphalt (2) | 140 | 100 | | 30 |
| | Blown asphalt | | | 100 | 70 |
| Component (B) | Polymer A | 130 | | | |
| Component (C) | Mesamoll II | 50 | | | |
| Component (F) | PM-100 | 10 | | | |
| Rubber component | SBR | | 15 | 15 | 15 |
| Silane coupling | A-1310 | 3 | | | |
| agent | | | | | |
| Filler | Calcium carbonate | 150 | 150 | 150 | 150 |
| | Talc | 50 | 50 | 50 | 50 |
| Curing catalyst | SCAT-27 | 2 | | | |
| Curing aid | Water | 2 | | | |
| | Zeolite 4A | 3 | | | |
| Workability | | Good | Not good | Not good | Not good |
| Odor | | Good | Not good | Not good | Not good |
| Curability | | Good | Good | Good | Good |
| Storage stability | | Good | Not good | Not good | Not good |

EX. = EXAMPLE,
C. EX = COMPARATIVE EXAMPLE

The damping material of EXAMPLE that required no heat-melting of the asphalt during working did not suffer from problematic thermal fluidity but had low viscosity and satisfactory workability. It also had sufficient room-temperature curability and storage stability.

### Blend Example for Road Paving Material

An example of a blend for a road paving material incorporating the curable composition of the present invention is as follows:

| | |
|---|---|
| Straight asphalt 150 to 200: | 140 parts by weight |
| Polymer A: | 130 parts by weight |
| Mesamoll: | 50 parts by weight |
| PM-100: | 10 parts by weight |
| A-1310: | 3 parts by weight |
| Aggregate: | 200 parts by weight |
| SCAT-27: | 2 parts by weight |
| Water: | 2 parts by weight |
| Zeolite 4A: | 3 parts by weight |

### Synthetic Example 6

A synthetic example of the component (E) and an example of a blend of the component (E) and the polymer A are as follows.

To 43 g of toluene heated to 110° C., a solution of 2.6 g of azobisisobutyronitrile serving as a polymerization initiator dissolved in a mixture of 6.0 g of butyl acrylate, 66 g of methyl methacrylate, 13 g of stearyl methacrylate, 5.4 g of γ-methacryloxypropylmethyldimethoxysilane, 7.0 g of γ-mercaptopropylmethyldimethoxysilane, and 23 g of toluene was added dropwise over 4 hours. The polymerization was then conducted for 2 hours to obtain a copolymer (polymer F) having a solid content of 60% and a number-average molecular weight of 2,200 (polystyrene equivalent) determined by GPC.

The polymer A obtained in SYNTHETIC EXAMPLE 1 was blended with the polymer F obtained in SYNTHETIC EXAMPLE 6 at a 70/30 solid content ratio (weight basis). The blend was heated at 110° C. under vacuum in an evaporator to remove volatile components. A clear, viscous liquid having a nonvolatile component content of 99% or more was obtained as a result. This mixture may be blended with the component (A) to prepare the curable composition of the present invention.

What is claimed is:

1. A curable composition comprising:
a bituminous substance (A); and
a saturated hydrocarbon polymer (B) having a reactive silicon group represented by general formula (1):
—Si(R¹₃₋ₐ)Xₐ (1)
(wherein R¹ is a C₁-C₂₀ alkyl group, a C₆-C₂₀ aryl group, a C₇-C₂₀ aralkyl group, or a triorganosiloxy group represented by (R′O)₃Si—; when two R¹s are present, they may be the same or different; the three R's each represent a C₁-C₂₀ monovalent hydrocarbon group and may be the same or different; X is a hydroxyl group or hydrolyzable group; when two or more Xs are present, they may be the same or different; and a is 1, 2, or 3).

2. The curable composition according to claim 1, wherein the saturated hydrocarbon polymer (B) has a main chain skeleton composed of polyisobutylene.

3. The curable composition according to claim 1, further comprising a plasticizer (C).

4. The curable composition according to claim 3, wherein the plasticizer (C) is an aromatic oligomer or a completely or partially hydrogenated aromatic oligomer.

5. The curable composition according to claim 3, wherein the plasticizer (C) is a sulfonate compound or a sulfonamide compound.

6. The curable composition according to claims 1, further comprising an epoxy resin (D).

7. The curable composition according to claim 6, wherein the epoxy resin (D) is contained in an amount of 5 to 120 parts by weight per 100 parts by weight of the bituminous substance (A).

8. The curable composition according to claim 1, further comprising a (meth)acrylic acid alkyl ester polymer (E).

9. The curable composition according to claim 8, wherein a molecular chain of the (meth)acrylic acid alkyl ester polymer (E) is a copolymer of a (meth)acrylic acid alkyl ester monomer unit (a) having a C₁-C₈ alkyl group and a (meth)acrylic acid alkyl ester monomer unit (b) having a C₁₀ or higher alkyl group.

10. The curable composition according to claim 8, wherein the (meth)acrylic acid alkyl ester polymer (E) is a polymer having a reactive silicon group represented by general formula (1).

11. The curable composition according to claim 1, further comprising a tackifier resin (F).

12. The curable composition according to claim 11, wherein the tackifier resin (F) is a tackifier resin modified with phenol and/or alkylphenol.

13. The curable composition according to claim 1, wherein the bituminous substance (A) comprises a natural asphalt and/or a petroleum asphalt.

14. A tile adhesive comprising the curable composition according to claim 1.

15. A waterproof material comprising the curable composition according to claim 1.

16. A road paving material comprising the curable composition according to according to claim 1.

17. A water stopping material for civil engineering, the water stopping material comprising the curable composition according to according to claim 1.

18. A damping material comprising the curable composition according to according to claim 1.
